(19) United States
(12) Patent Application Publication
(10) Pub. No.: US 2006/0031613 A1
(43) Pub. Date: Feb. 9, 2006

(54) Display replicate construct applied in portable information device

(76) Inventors: Yu Chen, Taipei City (JP); Yun-Ping Liu, Chilung city (JP); Kuo-Yin Huang, Luchou city (JP)

Correspondence Address: ROSENBERG, KLEIN & LEE, 3458 ELLICOTT CENTER DRIVE-SUITE 101, ELLICOTT CITY, MD, 21043, US

(21) Appl. No.: 10/945,978

(22) Filed: Sep. 22, 2004

(30) Foreign Application Priority Data
Aug. 3, 2004 (TW) 093212325

(51) Int. Cl. G06F 13/00

(52) U.S. Cl. 710/100

(57) ABSTRACT

A display replicate construct applied in portable information device discloses that the internal or external of an information device is installed with a connector to expand the display efficiency of the display module in the information device internally or externally. Therefore, the information device with low resolution display processing device can be linked to a high resolution display processing module by the connector, and via a switching module, the information device can manage the function of switching the two display processing modules as well so as to achieve the purpose of expanding the display efficiency of information device.

### BACKGROUND OF THE INVENTION

1. Field of the Invention

The present invention is related to a display replicate construct applied in portable information device, especially referring to a replicate construct of display processing device utilized in portable information device. Wherein, the internal of the information device is installed with a connector linked with a high resolution display processing device so as to achieve the purpose of expanding the display efficiency of information device.

2. Description of the Related Art

Accordingly, in the busy 21^{st} century, the convenient portable information device is a very important work company for the worker, such as notebook computer, which enables the worker to deal with the affairs any time including instantly checking and sending emails, writing reports, and processing general data in the long transport so as to prevent the time-consuming. Moreover, in the long journey, it can relax the exhaustion by playing music or video. In addition, the workers, who frequently have to get out to make a brief presentation or promote the company products, can utilize the portable information device to make the meeting record, brief presentation, or product introduction so that the heavy documentation, presentation data or product advertisement document can be dispensed and further promote the convenience and efficiency on the job.

Following the people's demand of computer software, the functions have been becoming ever strong and complete, especially the image processing function. This being the case, the display processing device, installed in the information device, such as display card or display chipset must be high efficiency so as to be compatible with high efficiency computer software, such as 3D graphic software, 3D image processing software, and game software. In comparison, it would take a lot of electricity if using high efficiency display processing device, and if the information device with the high efficiency display processing device runs the low efficiency display software, it would shorten the using life of information device after a long period of time of electricity supply of battery. However, until now, it would cause the inconvenience that the inside of information device can be only installed with just a display processing device.

In addition, generally the replicate device of portable information device is limited to the externally peripheral storage device such as disk drive, floppy disk, and hard disk. However, all of them would need different interfaces to connect with the portable computer or use a port replicator to achieve the purpose of expanding external peripheral device. Unfortunately, until now, the peripheral devices of replicate pedestal or port replicator in portable information device such as notebook computer don't include the interface of expanding display processing device, and the user cannot expand and choose the appropriate display processing device according to the desirable display efficiency to enhance the functions of the portable information device and achieve the electricity saving of battery.

Therefore, to conquer the problem that the portable information device can only have a single display processing device the present invention proposes a kind of display replicate construct applied in the portable information device, wherein there is a connector, which is utilized to install a second display processing device, in the information device, and, according to the running environment of the information device, the user can switch a proper information processing device via a switching module to solve the afore-mentioned problem.

### SUMMARY OF THE INVENTION

The purpose of the present invention is to offer a display replicate construct applied in the portable information device, wherein a connector is utilized to connect the chipset of the information device electrically. Further, via the linkage between the connector and another display processing device, it can achieve the purpose of expanding and advancing the display efficiency of information device via the same connector, wherein the connector can be the interface with the dimension of PCI, AGP, or ISA, and is installed internally or externally on the information device.

Another purpose of the present invention is to offer a display replicate construct applied in the portable information device, wherein the display processing device further comprises a switching module. As the connector is linked with a second display processing device, it can switch the desirable display efficiency via the switching module. For example, when the information device is internally installed with a first display processing device, the user can link a second display processing device via the connector and choose the desirable display processing device through the switching module.

To have a further understanding about the features of the structure and the achieved effects, of the present invention, the preferred embodiment and detailed description are unfolded as following.

### BRIEF DESCRIPTION OF THE DRAWING

FIG. 1, the first preferred embodiment of implementation depiction, depicts the display replicate construct applied in the portable information device in the present invention.

FIG. 2, the first preferred embodiment of implementation block diagram, shows the display replicate construct applied in the portable information device of the present invention.

FIG. 3, the second preferred embodiment of implementation block diagram, depicts the display replicate construct applied in the portable information device in of the present invention.

FIG. 4, the third preferred embodiment of implementation depiction, shows the display replicate construct applied in the portable information device of the present invention.

FIG. 5, the preferred embodiment of implementation block diagram, shows the display replicate construct applied in the portable information device of the present invention.

FIG. 6, the preferred embodiment of implementation block diagram, shows the display replicate construct applied in the portable information device of the present invention.

### DETAILED DESCRIPTION OF THE PREFERRED EMBODIMENT

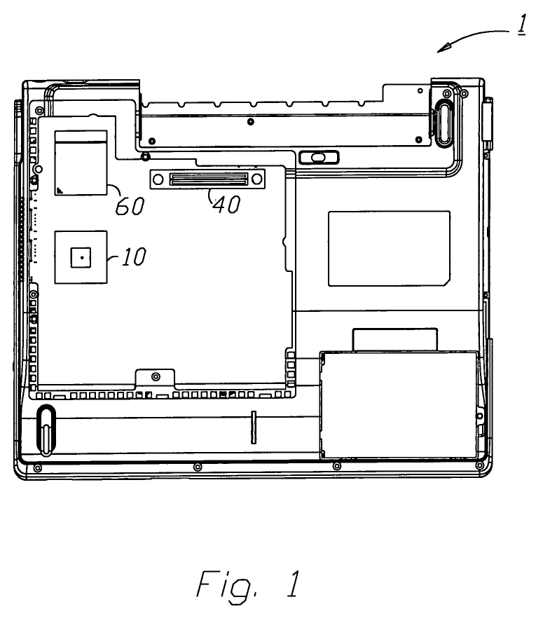

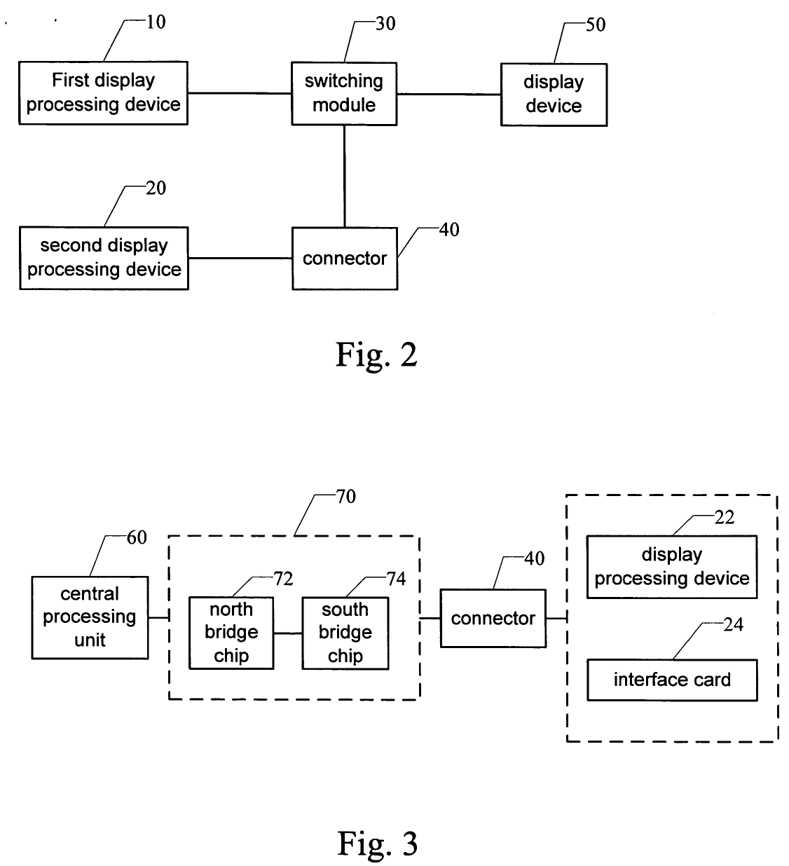

As shown in FIG. 1 and FIG. 2, figures depict the first preferred embodiment of implementation picture and implementation block diagram of display replicate construct in the portable information device of the present invention. As in FIG. 1, generally in the portable information device 1, there is a first display processing device (integrate VGA) 10 installed internally, and the resolution of the first display processing device 10 is of low level display efficiency. As shown in FIG. 2, which is the preferred embodiment of the present invention, therein, there is a connector installed internally or set on the notebook computer. And the connector 40 is linked with the second high efficiency display processing device 20 to offer the expandable construct so as to expand the efficiency of the display processing device in the portable information device 1. The main construct of the present invention comprises: a first display processing device (display card) 10; a switching module 30 (which is linked with the first display processing device 10 electrically); a connector 40 (which is linked with the switching module 30); and a second display processing device 20 (which is linked with the connector electrically). Wherein, the switching module 30 is utilized to switch the display processing signals outputted from the first display processing device 10 and the second display processing device 20.

In addition, the switching module 30 is linked with a display device 50 electrically to offer the display signal output of the switching, and the connector 40 can be installed on the motherboard. The first display processing device 10 is an internally installed display card or display chipset, and the second display processing device 20 is linked with the connector 40 so that the user can choose and expand the desirable display processing device with different display efficiency via the switching module 30 and the connector 40.

As shown in FIG. 3, which is the second preferred embodiment of implementation block diagram, the figure depicts the display replicate construct applied in the portable information device of the present invention. As in FIG. 3, the replicate construct comprises: a central processing unit 60, a chipset 70, a connector 40, and a display processing device 22. The central processing unit 60 is connected with the chipset 70, and the chipset 70 includes a north bridge chip 72 and a south bridge chip 74. Moreover, the chipset 70 is linked with the display processing device 22 through the connector 40. Wherein, the connector 40, which is externally installed on the information device, can be linked with an interface card 24 of desktop computer, such as SCSI card, DVD hardware capture card, good TV plus, or TV tuner, and etc.

Besides, the display processing device 22 refers to an accelerated graphic port or a peripheral component interconnection. In the preferred embodiment of the present invention, the connector 40 has the interface with the dimension of PCI, AGP, or ISA, and etc., so that the information device can be linked with the display processing device with the interface of relative specification, or directly be installed in the north bridge chip 72 internally. Via the connector 40, the portable information device can be connected to the display card in the desktop computer with PCI socket or the display processing device with the interface socket complying with the electrical characteristics of the connector 40.

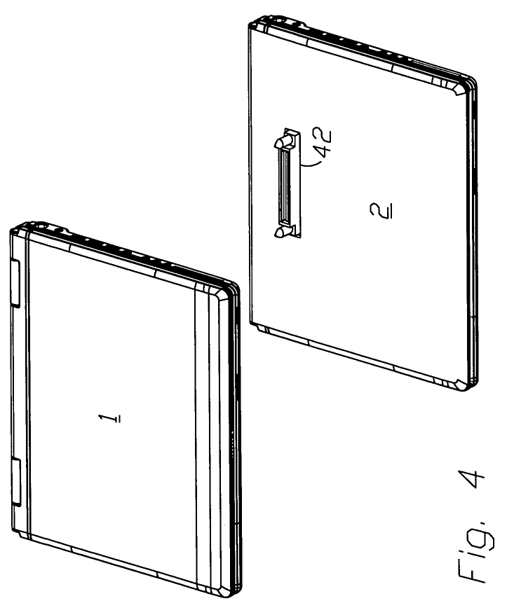

FIG. 4, the third preferred embodiment, depicts the display replicate construct applied in portable information device in the present invention. As shown in FIG. 4, the connector can be extended to the surface such as bottom of a portable computer 1, and connected with the portable computer by utilizing the replicate cradle structure of conventional art. The portable computer 1 is electrically linked with the connecting socket 42 of a replicate cradle 2 via a connector 40. The replicate cradle 2 includes a second display processing device or a interface card of a desktop computer such as SCSI card, DVD hardware capture card, good TV plus, or a TV turner, and so on.

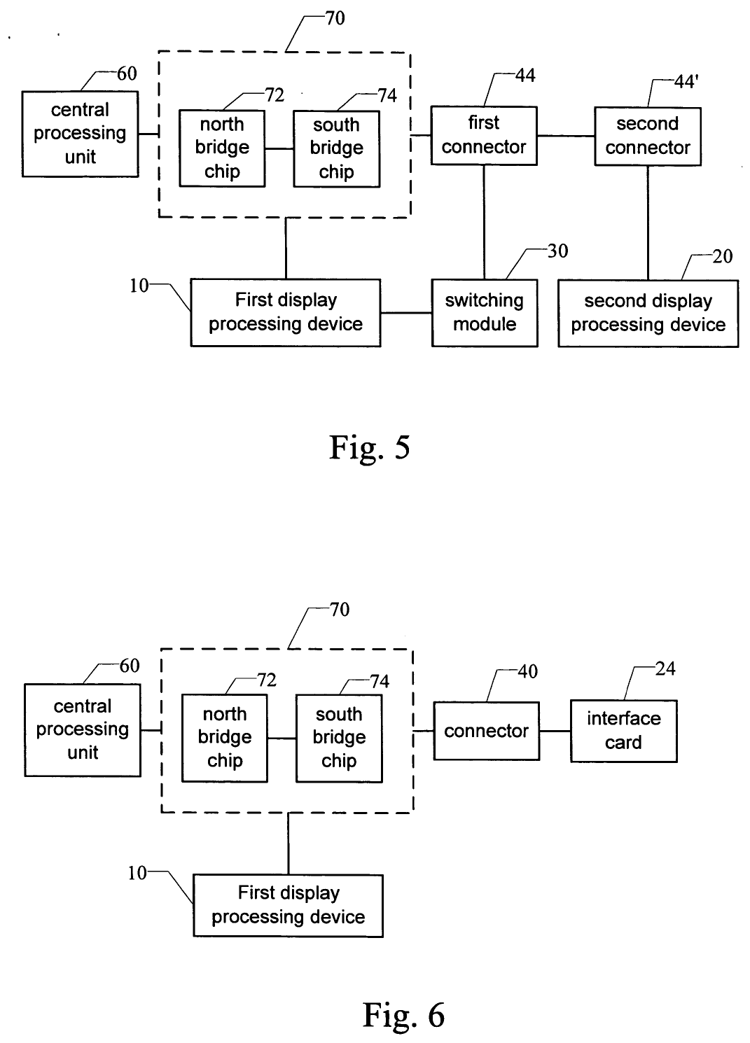

FIG. 5, the third preferred embodiment of block diagram, depicts the display replicate construct applied in portable information device of the present invention. As shown in FIG. 5, the replicate construct comprises: a central processing unit 60, a chipset 70, a first display processing device 10, a switching module 30, a first connector 44, a second connector 44′, and a second display processing device 20. Wherein, the central processing unit 60 is linked with the chipset 70, and the first display processing device 10 is the internally installed display card or display chip and connected by the switching module 30. The first connector 44 is linked separately with the chipset 70, the switching module 30, and the second connector 44′. Moreover, the second connector 44′ is linked with the second display processing device 20.

Wherein, the first connector 44 is internally installed on the motherboard, and the second connector 44′ is externally installed on the flexible printed circuit board (which is extended by the connector 44) located on the surface of the information device (such as the bottom or the replicate surface) so that the user can choose to link the second display processing device 20 to the first connector 44 inside the server or choose to expand and link the second display processing device 20 to the second connector 44′ outside the server directly accordingly to the environmental request.

Under the reference of FIG. 3 and FIG. 5, FIG. 6, the third preferred embodiment of block diagram, indicates the display replicate construct applied in the portable information device of the present invention. As shown in FIG. 6, when the connector 40, 44, or 44′ merely link the interface card (such as SCSI card, DVD capture card good TV plus, or TV turner, and etc.), the switching module 30 would be no necessary.

In conclusion, the present invention is related to a kind of display replicate construct applied in the portable information device, wherein a connector is disclosed to expand the display function of the portable computer. Therefore, the portable computer of low resolution in the conventional art can linked with a high resolution display card via a switching module and a connector to manage the replication of the portable computer. Because of the electrical capacity of the battery, generally the portable computers adopt the display processing devices of low resolution, but it would strongly cause the less practice of the notebook computer than desktop computer because it is unable to switch to the display processing device of high resolution for the notebook computer. Therefore, the present invention is to offer a switching module 30 and a connector 40 so that the user can choose the desirable display processing devices of different resolution via the switching module 30 and the connector 40.

In conclusion, this invention definitely achieves creativity, improvement, and more usability for the users in the industry. This being the case, it should be qualified for the patent applications in the intellectual patent regulation of our country, thus being proposed for the approval of the patent. Looking forward to the kind rendering of the approval at the earliest convenience.

The above-mentioned practice is only a preferred embodiment of this invention, not the specified limit of it. All the parallel changes and revisions of the shape, the structure, the feature, and the spirit evolving from this invention should be included in the field of the claimed patent of this invention.

What is claimed is:

1. A display replicate construct applied in the portable information device comprising:
a first display processing device;
a switching module, which is electrically linked with the first display processing device;
a connector, which is linked with the switching module; and
a second display processing device, which is electrically linked with the connector,
wherein the switching module is utilized to switch the signal outputted from the first display processing device and the second display processing device.

2. The display replicate construct as claimed in claim 1, wherein the first display processing is electrically linked with a south bridge chip or a north bridge chip.

3. The display replicate construct as claimed in claim 1, wherein the second display processing device is electrically linked with a south bridge chip or a north bridge chip.

4. The display replicate construct as claimed in claim 1, wherein the first display processing device is installed in a north bridge chip.

5. The display replicate construct as claimed in claim 1, wherein the first display processing device includes an accelerated graphic port.

6. The display replicate construct as claimed in claim 1, wherein the second display processing device includes a peripheral component interconnect.

7. The display replicate construct as claimed in claim 1, wherein the first display processing device refers to a display chip or a display card internally installed on the main board.

8. The display replicate construct as claimed in claim 1, wherein the connector is internally installed on the main board.

9. The display replicate construct as claimed in claim 8, wherein the connector is utilized to link a second display processing devices.

10. The display replicate construct as claimed in claim 1, wherein the connector is externally installed on the information device.

11. The display replicate construct as claimed in claim 10, wherein the connector is utilized to link the first display processing device or the second display processing device.

12. The display replicate construct as claimed in claim 10, wherein the connector is to link the second display processing device, and the first display processing device refers to the internally installed display card or display chip.

13. The display replicate construct as claimed in claim 1, wherein the connector is internally installed on the mainboard and extends to the surface of the server via a flexible printed circuit board.

14. A display replicate construct applied in the portable information device comprising:
a central processing unit (CPU);
a chipset, which is electrically linked with the central processing device;
a connector, which is electrically linked with the chipset; and
a peripheral device, which is electrically linked with the connector.

15. The display replicate construct as claimed in claim 14, wherein the chipset includes a north bridge chip and a south bridge chip.

16. The display replicate construct as claimed in claim 14, wherein the connector is externally installed on the information device.

17. The display replicate construct as claimed in claim 16, wherein the connector is linked with the peripheral devices, and the peripherals comprises a display processing device and an interface card, used in the desktop computer.

18. The display replicate construct as claimed in claim 17, wherein the interface card of the desktop computer includes a SCSI card, DVD hardware capture card, good TV plus, or a TV turner.

19. The display replicate construct as claimed in claim 17, wherein the display processing device includes a switching module
